(19) United States
(12) Patent Application Publication
(10) Pub. No.: US 2022/0204805 A1
(43) Pub. Date: Jun. 30, 2022

(54) REACTIVE POLYESTER RESIN BASED ON A HYDROXYLATED AND/OR EPOXIDIZED FATTY ACID TRIGLYCERIDE POLYOL FOR COATINGS WITH HIGH SOLIDS CONTENT

(71) Applicant: Arkema France, Colombes (FR)

(72) Inventors: Laurent Piffoux, Verneuil En Halatte (FR); Jean-Yves Hamel, Verneuil En Halatte (FR); Herve Ozeray, Verneuil En Halatte (FR); Alain Riondel, Verneuil En Halatte (FR); Benoit Satz, Verneuil En Halatte (FR)

(21) Appl. No.: 17/601,776

(22) PCT Filed: Apr. 23, 2020
(86) PCT No.: PCT/EP2020/061342

§ 371 Date: Oct. 6, 2021

(30) Foreign Application Priority Data
Apr. 24, 2019 (FR) FR19.04303

(51) Int. Cl. C09D 167/08; C08G 63/54; C08G 63/91; C09D 7/20

(52) U.S. Cl. CPC C09D 167/08; C09D 7/20; C08G 63/918; C08G 63/54

(57) ABSTRACT

The invention relates to a hydroxylated and/or carboxylated polyester resin, which comprises, in its structure, ester units formed from a polyol component a) comprising at least one polyol al) chosen from hydroxylated and/or epoxidized fatty acid triglycerides of general formula (I): R-CO2-(H)C-(CH2-CO2-R)2 (I) with R being the residue radical without a carboxyl group of a hydroxylated and/or epoxidized fatty acid RCO2H with R comprising from 13 to 21 carbon atoms and at least one hydroxyl and/or epoxy group. The invention also relates to a crosslinkable coating composition in an organic solvent medium comprising said resin, just like the coating which results from this use.

The present invention relates to a reactive, hydroxylated and/or carboxylated, polyester resin, having a specific composition, characterized in particular by the specific selective choice of its polyol component and more particularly in combination with a specific choice of its polyacid component, with said polyol component comprising, as polyol, a hydroxylated and/or epoxidized fatty acid triglyceride (triglyceride). In particular, said polyol is free from monoalcohols and more particularly the polyacid component is free from unsaturated or saturated fatty monoacids. Said resin is a resin in a solvent medium having a high solids content of at least 50%, preferably of at least 60%, more preferentially of 65% to 90% and more preferentially still of 65% to 85% by weight and with a viscosity suitable for coatings comprising a high solids content and in particular having in addition a high covering power, more particularly for coatings of metal sheets (coil coatings) or coatings for metal packaging (packaging coatings).

WO2016/203136 already describes reactive, hydroxylated and/or carboxylated, polyester resins having a zero oil content, for coatings with a high solids content and a high covering power. No specific presence of hydroxylated and/or epoxidized fatty acid triglyceride polyol is described or suggested, nor its effect on the improved performance qualities obtained.

The objective of the present invention is thus to improve, through the specific structure of the binding resin used, the solids content with a content by weight of at least 50% in organic solvent medium, as mentioned above, while maintaining a viscosity of the coating composition suitable for the final application, in particular for application to metal sheets or for metal packaging. This “suitable” viscosity should be a Brookfield viscosity of less than 1000 mPa·s at the application temperature ranging from 15 to 35° C., said Brookfield viscosity being measured according to the ISO 3219 method. With regard to the targeted resin, it should have a viscosity of less than 20 000 mPa·s in solution in an organic solvent at 25° C. with a resin content (solids content) of 80% by weight. With regard to the high covering power of said coating comprising said resin, it is preferably greater than 400 m² per kg of coating for a thickness of 1 μm. In particular, an increase (improvement or gain in coverage) of at least 8% and preferably of 9% to 20% in the covering power is obtained with respect to a coating comprising a polyester resin which does not have the specific resin composition as defined according to the present invention. The high covering power of said coating according to the invention makes possible in particular a significant improvement in the protection against corrosion of said metal sheets thus coated or of said metal packaging thus coated.

The present invention relates first to a hydroxylated and/or carboxylated polyester resin of specific structure obtained from a specific composition of polyol component a) of said resin.

The invention also relates to a solution of said resin in an organic solvent, in particular at a resin content with respect to the weight of said solution of at least 50%, preferably of at least 60%, in particular ranging from 60% to 90%, more preferentially from 65% to 90% and more preferentially still from 65% to 85%.

The invention also covers a crosslinkable composition comprising said resin, in particular a coating composition and more particularly a coating composition for metal sheets or for metal packagings.

Also covered is the use of said resin or of a solution of said resin as binder in a coating composition in an organic solvent medium, in particular for crosslinkable coatings and more particularly for increasing the covering power of said coating or for protective coatings, in particular for protecting metal from corrosion.

Another subject matter of the invention is the finished product, which is a coating which results from the use of said resin or of a solution of said resin or of a crosslinkable composition containing it, in particular having an increased (improved) covering power with respect to other common polyester resins.

The first subject matter of the invention relates to a hydroxylated and/or carboxylated polyester resin, which comprises, in its structure, ester units formed from a polyol component a) comprising at least one polyol a1) chosen from hydroxylated and/or epoxidized fatty acid triglycerides of general formula (I):

R—CO₂—(H)C—(CH₂CO₂—R)₂ (I)

with R being the residue radical without a carboxyl group of a hydroxylated and/or epoxidized fatty acid RCO₂H with R comprising from 13 to 21, preferably from 13 to 19, carbon atoms and at least one hydroxyl and/or epoxy group.

The resin comprises units formed from a polyol component a). In other words, this means that the resin is obtained from a composition comprising a polyol component a).

Said polyol component a) according to the invention can comprise both polyhydroxylated and/or epoxidized, including polyepoxidized, compounds (or derivatives). In particular, the epoxidized compounds are categorized in the polyol component a) in so far as they react like a polyol component with respect to a polyacid by formation of ester bonds.

According to a specific option of said polyester resin, said triglyceride is chosen from the triglycerides of 9- and/or 10-hydroxystearic acid, 12-hydroxystearic acid, 14-hydroxyeicosanoic acid, 12-hydroxy-9-octadecenoic acid and/or its epoxidized form, lesquerolic acid (14-hydroxy-cis-11-eicosenoic acid) and/or its epoxidized form, or epoxidized soybean oil.

According to a particularly preferred option, said hydroxylated fatty acid is 12-hydroxystearic acid or 12-hydroxy-9-octadecenoic acid, which means that said triglyceride is hydrogenated castor oil or nonhydrogenated castor oil, preferably hydrogenated castor oil.

More particularly, the content by weight of said polyol triglyceride al) with respect to the weight of said resin varies from 1% to 30%, preferably from 2% to 25%, more preferentially from 2% to 15%, more preferentially still from 3% to 12%, in a more preferred way from 4% to 10%.

Within the meaning of the present invention, the expression “the content by weight of the component Y with respect to the weight of the resin varies from 1% to 30%” means that the units formed from component Y represent from 1% to 30% by weight of the total weight of the resin. In other words, this means that the resin is obtained from a composition comprising from 1% to 30% by weight of component Y with respect to the weight of the composition.

According to one embodiment, said polyol al) represents from 5% to 20%, in particular from 10% to 15%, by weight of said polyol component a).

According to a more specific option of the polyester resin according to the invention, said polyol component a) comprises, in addition to said polyol a1): a2) at least one C₂ to C₆ diol carrying at least one methyl side substituent, in particular (carrying) two C₁-C₄ side substituents, preferably said diol being a C₂ to C₄ diol.

More particularly, the content by weight of the diol a2) with respect to the weight of said resin varies from 0% to 50%, preferably from 20% to 40%, more preferentially from 25% to 35%.

According to one embodiment, said polyol a2) represents from 50% to 80%, in particular from 60% to 75%, by weight of said polyol component a).

According to a more specific option of said resin, said polyol component a) additionally comprises:
a3) at least one linear C₂ to C₆ aliphatic diol, without any alkyl side substituent, and/or one C₆ to C₁₀ cycloaliphatic diol and/or one C₃₂ to C₃₆ fatty diol, in particular derived from a C₃₂ to C₃₆ fatty acid dimer diacid.

More particularly, the content by weight of the diol a3) with respect to the weight of said resin varies from 0% to 20%, preferably from 2% to 15%, more preferentially from 5% to 10%.

According to one embodiment, said polyol a3) represents from 10% to 30%, in particular from 15% to 25%, by weight of said polyol component a).

According to a specific embodiment, the polyol component a) comprises the polyol a1), the diol a2) and the diol a3).

The polyol component a) can in particular represent from 20% to 60%, in particular from 30% to 50%, more particularly from 35% to 45%, by weight of the weight of the resin.

More particularly still in said resin, said polyol component a) additionally comprises:
a4) at least one polyol of functionality >2 and preferably of functionality 3 or 4, more preferentially 3,
and (in this case) said resin has a branched structure.

A branched structure means that the structure of the chain of said resin comprises side polyester segments, related to the functionality of greater than 2 of the polyol a4).

Said triglyceride polyol a1) can be a triglyceride which results from the hydrogenation of the corresponding unsaturated hydroxylated oil: the triglyceride of 12-hydroxystearic acid from the hydrogenation of castor oil (ricinoleic acid triglyceride) or the triglyceride of 14-hydroxyeicosanoic acid from the hydrogenation of the triglyceride of 14-hydroxy-cis-11-eicosenoic acid (the triglyceride of lesquerolic acid).

Mention may be made, as suitable components a2), of: methylethylene glycol, methylpropanediol, neopentyl glycol (2,2-dimethyl-1,3-propanediol), dimethyl butanediol or 2-butyl-2-ethyl-1,3-propane diol, and preferably neopentyl glycol or 2-butyl-2-ethyl-1,3-propane diol.

Mention may be made, as suitable linear aliphatic diol components a3), of ethylene glycol, diethylene glycol, propylene glycol, dipropylene glycol, butanediol, pentanediol or hexanediol, preferably ethylene glycol and hexanediol. Mention may be made, as cycloaliphatic diol a3), of cyclohexanediol or cyclohexanedimethanol. Mention may be made, as fatty diol a3), of fatty diols derived from C₃₂ to C₃₆ fatty acid dimers with it being possible for said fatty diol to be hydrogenated or nonhydrogenated. For example, said C₃₂ to C₃₆ fatty diols can be obtained by reduction of the carboxyl groups of C₃₂ to C₃₆ fatty acid dimers, more particularly by catalytic hydrogenation of said fatty acid dimers with replacement of the carboxyl groups by hydroxyl groups (reduced form of the carboxyl groups).

Mention may be made, as suitable components a4), of: glycerol and trimethylolpropane.

The resin according to the invention comprises, in its structure, ester units formed from a polyol component a) and from a polyacid component b). In other words, this means that the resin is obtained from a composition comprising a polyol component a) and a polyacid component b).

The polyacid component b) can in particular comprise diacids, diacid derivatives or anhydrides.

More particularly still, said resin according to the invention has a polyacid component b) which comprises:
b1) at least one aromatic diacid or its anhydride, preferably representing from 20% to 75% by weight of said resin,
b2) optionally, at least one linear C₄ to C₁₀, preferably C₄ to C₈, aliphatic diacid or its anhydride and/or at least one C₃₂ to C₃₆ fatty acid dimer diacid,
b3) optionally, at least one cycloaliphatic diacid or its anhydride.

The diacids b1), b2) and b3) can be diacid derivatives. Within the meaning of the present invention, a diacid derivative is a compound which can be converted into a diacid by hydrolysis or transesterification. The diacid derivatives include the partially or completely esterified forms of the diacids defined above, in particular the C₁-C₆ alkyl mono- and diesters of the diacids defined above.

The polyacid component b) can in particular represent from 40% to 80%, especially from 50% to 70%, more particularly from 55% to 65%, by weight of the weight of the resin.

According to a specific composition of said resin, the polyacid component b) is constituted essentially of the diacid b1) or its anhydride.

According to a specific composition of said resin, the polyacid component b) of said resin comprises (in addition to the diacids b1) and b2)) at least one cycloaliphatic dicarboxylic acid b3) or its anhydride.

According to one embodiment, the content by weight of b1), with respect to the weight of said resin, varies from 20% to 75%, in particular from 50% to 70%, more particularly from 55% to 65%.

Mention may be made, as aromatic diacid b1) or its anhydride, of isophthalic acid, terephthalic acid or phthalic anhydride.

Mention may be made, as linear aliphatic diacid b2) or its anhydride, of malonic acid, adipic acid, succinic acid, azelaic acid or sebacic acid and, as C₃₂ to C₃₆ fatty acid dimer diacid, of a fatty acid dimer derived from tall oil or from rapeseed oil, which is hydrogenated or nonhydrogenated, and succinic anhydride.

Mention may be made, as cycloaliphatic diacid b3) or its anhydride, of cyclohexanedicarboxylic acid, hexahydrophthalic acid and hexahydrophthalic anhydride.

A “substituted Cₙ diol” means that it has n carbon atoms linked together (connected together in a chain) apart from the side substituents, which are not counted in said number n. The term “Cₙ” is understood to mean the length of the carbon chain (—C—C—) carrying the 2 hydroxyl groups, the substituents being carried by these same n atoms.

The term “Cₙ polyacid” means that said polyacid has n carbons, including the carbons of the carboxyl (—CO₂H) groups.

Said diol a2) is preferably selected from: neopentyl glycol (2,2-dimethyl-1,3-propanediol) or 2-butyl-2-ethyl-1,3-propanediol and in particular neopentyl glycol.

Preferably, said polyol a2) represents less than 75% by weight of said polyol component a).

According to a specific embodiment, the resin has a hydroxyl number of 0 to 200, of 10 to 120, of 15 to 100, of 20 to 80, of 25 to 75, of 30 to 60 or of 35 to 50 mg KOH/g.

According to a specific embodiment, the resin has a carboxyl number of less than or equal to 20, of less than or equal to 15, of less than or equal to 10, of less than or equal to 7 or of less than or equal to 5 mg KOH/g. The carboxyl number can in particular range from 0 to 20, from 0.1 to 15, from 0.5 to 10, from 1 to 7 or from 2 to 5 mg KOH/g.

Preferably, said resin has a hydroxyl number or a carboxyl number or an overall hydroxyl+carboxyl number ranging from 5 to 200, preferably from 10 to 175, mg KOH/g.

Said resin according to the invention has in particular a glass transition temperature, measured by DSC, at 10° C/min, in two passes, of −10° C. to 100° C., preferably of −10° C. to 50° C. and more preferentially of 0° C. to 40° C.

According to a particularly preferred option of said resin, at least 50%, preferably at least 75%, by weight of said resin is biobased.

More particularly, said resin according to the invention is hydroxylated.

According to a more specific option, said resin has a number-average molecular weight Mₙ (calculated, in particular from the OH and acid numbers and from the material balance, as explained in detail below before the experimental part) ranging from 500 to 20 000, preferably from 750 to 10 000.

According to a specific option, the two components a3) and a4) are present as essential components with the other components a1) and a2) as defined above.

Said polyester resin can be prepared by a polycondensation reaction of the polyol and polyacid components premixed and heated in the bulk molten state in a single stage with removal of the water eliminated either under vacuum or in the presence of a solvent forming an azeotrope with the water eliminated, such as xylene. Such a process is already described in the description and examples of WO2016/203136. Said resin can be prepared by a polycondensation reaction between the polyol component a) and the polyacid component b) as are defined above. The reaction can take place in a solvent medium or in the bulk molten state, as already known to a person skilled in the art. When the reaction is carried out in the presence of a solvent as azeotropic entrainer in order to remove the water, the solvent preferentially chosen is xylene.

The reaction is advantageously carried out in the presence of a catalyst. Use may be made, as catalyst, of alkyl titanates, such as, for example, isopropyl titanate, butyl titanate or 2-ethylhexyl titanate, or tin derivatives, such as, for example, tin oxide, tin oxalate or monobutyltin oxide. The amounts of catalyst used are comprised between 100 and 5000 ppm, with respect to all of the monomers, and preferably from 500 to 1500 ppm, still with respect to all of the monomers.

A second subject matter of the invention relates to a solution of resin in an organic solvent, which solution comprises, in addition to said solvent, at least one resin as defined above according to the invention.

In particular, as regards said solution, the content by weight of said resin with respect to the resin+solvent total weight is at least 50%, in particular at least 60%, and preferably varies from 60% to 90%, more preferentially from 65% to 90% and more preferentially still from 65% to 85%.

As organic solvent suitable for preparing said resin solution, said solvent can be selected from methyl esters or ethyl esters of C₂ to C₄ monocarboxylic acids, or esters of said monocarboxylic acids with methoxy or ethoxy monoethers of C₂ to C₄ diols, in particular methoxypropyl acetate, or from dimethyl or diethyl esters of C₄ to C₆ dicarboxylic acids, terpenes, polyhydroxyalkanoates, methyl or ethyl esters of oils of fatty acids or esters of lactic acid with C₁ to C₈ alcohols, aromatic solvents, such as xylene or other aromatic solvents which are distillation cuts of hydrocarbons comprising 9 carbon atoms with a boiling point (b.p.) ranging from 155 to 180° C. of Solvarex® 9 type or distillation cuts of aromatic hydrocarbons comprising 10 carbon atoms with a b.p. ranging from 180 to 193° C. of Solvesso® 150 ND type, optionally as a mixture with glycol monoethers, such as butyl glycol (or butoxyethanol).

Preferably, said solvent is selected from aromatic solvents, as defined above, alone or as a mixture with glycol monoethers, such as, for example, the mixture of a C₉ distillation cut with a b.p. ranging from 155 to 180° C., such as Solvarex® 9, with butyl glycol. Said solvent can be the solvent of preparation of said resin if prepared by polycondensation in a solvent medium or a solvent of dissolution after preparation by bulk polycondensation. The solids content can be adjusted by extra addition of solvent if the resin is prepared at the start in a solvent. Said solvent can be a mixture of at least two solvents among those mentioned above.

Another subject matter of the invention relates to a coating composition, preferably in an organic solvent medium, more particularly a crosslinkable composition, comprising at least one resin as defined above according to the invention or a resin solution as defined above.

More particularly, the coating composition according to the invention is crosslinkable and comprises, in addition to said resin, at least one crosslinking agent carrying groups which react with the reactive groups of said resin.

Said crosslinking agent is preferably selected from melamine, benzoguanamine or a polyisocyanate, including and in particular blocked polyisocyanate, or a polyanhydride or a polysilane, in particular alkoxy-blocked polysilane, when said resin is hydroxylated, or said crosslinking agent is selected from polyepoxides or polyols when said resin is carboxylated.

The composition according to the invention is in particular a coating composition in an organic solvent medium. More particularly, it is a paint or varnish composition and more particularly still a paint or varnish composition for metal surfaces.

This coating composition can be applied for:
top coats (on primer) or monolayer (direct on metal),
primers,
backing coats. They are coatings for the internal part of the metal sheet not exposed to bad weather or to light.

According to a particular preferred option, said composition comprises, in addition to said resin and said crosslinking agent, at least one pigment.

Another subject matter of the invention relates to the use of a resin or of a resin solution as defined according to the invention in crosslinkable coating compositions in an organic solvent medium. More particularly, according to a first option, it concerns coating compositions having a “one-component” behavior for metal, in particular for coating on metal sheet (coil coating) or for metal packaging (packaging coatings). According to a second alternative option, it concerns “two-component” coatings.

Said use according to the invention can also relate to powder coatings, in particular for metal.

Preferably, in said use according to the invention, said coating is pigmented and said use is for coatings having a high covering power for a coating for protection against corrosion.

Finally, the invention relates to a coating which results from the use of at least one resin or of a resin solution or of a coating composition as defined above according to the invention. More particularly, said coating is a metal sheet coating (coil coating) or protective coating, in particular for protecting metal against corrosion. More particularly still, it can be a primer, top coat, monolayer or backing coat.

The OH number is measured according to the ISO 2554 method and the acid number is measured according to the ISO 2114 method.

The Mₙ value is calculated from the measured hydroxyl number and the measured acid number, which make it possible to calculate an equivalent mass M_{eq} per functional group (OH or carboxyl or sum of the two if both are present) and number-average functionality of the resin, this average functionality fₘ being calculated from:

fₘ=Σᵢxᵢ*fᵢ/Σᵢxᵢ

with xᵢ being the number of moles of component i (acid or alcohol) and fᵢ being the functionality of said component i
the equivalent mass M_{eq} is defined by M_{eq}=56 000/(I_{OH}+I_{acid})
Thus, M_{n calculated}=M_{eq}*fₘ

The following examples are set out below by way of illustration of the invention and of its performance qualities and do not in any way limit the scope of the invention.

### Experimental Part

### 1) Preparation of the Resin for Primer

1.1) Table of the Starting Materials Used (see table 1)

TABLE 1

| | | | | Nature | Compo- |
|---|---|---|---|---|---|
| | | | | of the | nent ac- |
| | | | Techni- | chemical | cording |
| Starting | Chemical | Sup- | cal | function- | to the |
| material | name | plier | function | ality | invention |
| PAN | Phthalic | Polynt | Monomer | Carboxyl/2 | Diacid b1) |
| | anhydride | | | | |
| ISO | Isoph- | Penpet | Monomer | Carboxyl/2 | Diacid b1) |
| | thalic | | | | |
| | acid | | | | |
| EG | Ethylene | Dow | Monomer | Hydroxyl/2 | Diol a3 |
| | glycol | | | | |
| NPG | Neopentyl | Perstorp | Monomer | Hydroxyl/2 | Diol a2 |
| | glycol | | | | |
| HCO | Hydro- | Jayant | Monomer | Hydroxyl/3 | Polyol |
| | genated | | | | triglycer- |
| | castor oil | | | | ide a1 |
| Solvarex ® | Aromatic | Total | Solvent | | Solvent |
| 9 | solvent | | of the | | of the |
| | | | resin | | resin |
| Fascat ® | Monobut- | PMC | Catalyst | | Catalyst |
| 4100 | yltin | Organo- | | | |
| | oxide | metallix | | | |
| Xylene | Xylene | Total | Azeo- | | Azeo- |
| | | | tropic | | tropic |
| | | | entrain- | | solvent |
| | | | ing | | |
| | | | solvent | | |

1.2) Procedure for preparation of the resin: according to the invention (example 1) and comparative test 1 without HCO (see table 2 for the proportions) In a 1.5 I glass reactor equipped with:
a distillation column of the Vigreux type surmounted by a Dean and Stark separator,
a dip pipe for introducing nitrogen,
a temperature probe,
the monomers are charged in amounts as described in table 2 below.

The synthesis takes place at 220° C. maximum in the presence of a catalyst (Fascat® 4100: 0.08 g) and of xylene as azeotropic entrainer (30 g) in order to remove the water from the reaction.

The resin according to the invention and according to the comparative example is diluted in Solvarex® 9 (as supplement in order to have the solids content presented in table 2).

The characteristics of the two resins are given in table 2.

Compositions and characteristics of the resins (apart from solvent, catalyst and azeotropic entrainer) according to the invention (example 1) and comparative test 1

TABLE 2

| | | Test according to |
|---|---|---|
| | Comparative | the invention |
| | test 1 | (example 1) |
| Phthalic anhydride | 203 | 184 |
| Isophthalic acid | 440 | 398 |
| Ethylene glycol | 150 | 69 |
| Neopentyl glycol | 207 | 299 |
| HCO | 0 | 50 |
| TOTAL | 1000 | 1000 |
| Resin hydroxyl number (mg KOH/g) | 42 | 45 |
| (ISO 2554 method) | | |
| Resin acid number (mg KOH/g) | 3.1 | 3.5 |
| (ISO 2114 method) | | |
| Solids content (%) (ISO 3251 | 64.7 | 64.5 |
| method) | | |
| Brookfield viscosity at 25° C. | 11 200 | 4000 |
| (mPa · s) (ISO 3219 method) | | |
| with the solids content indicated | | |

### 2) Preparation of the Resin for Top Coat

2.1) Table of the Starting Materials used (see table 3)

### Starting Materials used vs Resin for Top Coat

TABLE 3

| | | | | | Typical |
|---|---|---|---|---|---|
| | | | | Nature | composi- |
| | | | | of the | tion ac- |
| | | | Techni- | chemical | cording |
| Starting | Chemical | Sup- | cal | function- | to the |
| material | name | plier | function | ality | invention |
| PAN | Phthalic | Polynt | Monomer | Carboxyl/ | Diacid b1) |
| | anhydride | | | 2 | |
| AA | Adipic | BASF | Monomer | Carboxyl/ | Diacid b2) |
| | acid | | | 2 | |
| EG | Ethylene | Dow | Monomer | Hydroxyl/ | Diol a3 |
| | glycol | | | 2 | |
| NPG | Neopentyl | Perstorp | Monomer | Hydroxyl/ | Diol a2 |
| | glycol | | | 2 | |
| TMP | Trimethylol | Lanxess | Monomer | Hydroxyl/ | Diol a4 |
| | propane | | | 3 | |
| HCO | Hydro- | Jayant | Monomer | Hydroxyl/ | Polyol |
| | genated | | | 3 | triglycer- |
| | castor oil | | | | ide a1 |
| Solvarex ® | Aromatic | Total | Solvent | | Solvent |
| 9 | solvent | | of the | | of the |
| | | | resin | | resin |
| Fascat ® | Monobut- | PMC | Catalyst | | Catalyst |
| 4100 | yltin | Organo- | | | |
| | oxide | metallix | | | |
| Xylene | Xylene | Total | Azeo- | | Azeo- |
| | | | tropic | | tropic |
| | | | entrain- | | entrain- |
| | | | ing | | ing |
| | | | solvent | | solvent |

2.2) Procedure for Preparation of the Resin: According to the Invention (Example 2) and Comparative Test 2 without HCO

The procedure used is identical to that described in point 1.2) (the amounts are given in table 4).

The resin according to the invention and according to the comparative example is diluted in pure Solvarex® 9.

The characteristics of the two resins are also given in table 4. Compositions and characteristics of the resins (apart from solvent, catalyst and azeotropic entrainer) according to the invention (example 2) and comparative test 2

TABLE 4

| | | Test according to |
|---|---|---|
| | Comparative | the invention |
| Resin component/characteristics | test 2 | (example 2) |
| Phthalic anhydride | 450 | 570 |
| Adipic acid | 140 | 0 |
| Ethylene glycol | 70 | 95 |
| Neopentyl glycol | 300 | 280 |
| HCO | | 55 |
| Trimethylolpropane | 40 | 0 |
| TOTAL | 1000 | 1000 |
| Resin hydroxyl number (mg KOH/g) | 45 | 35 |
| (ISO 2554 Method) | | |
| Resin acid number (mg KOH/g) | 3.3 | 2.7 |
| (ISO 2114 Method) | | |
| Solids content (%) (ISO 3251 | 75.4 | 76 |
| method) | | |
| Brookfield viscosity at 25° C. | 18 000 | 16 000 |
| (mPa · s) (ISO 3219 method) | | |
| at the solids content indicated | | |

### 3) Application of the Resins in Paints for Metal Sheet

3.1) Metal Sheet and Conditions for Application of the Coating/Packaging before Tests

The sheeting used for the tests is galvanized steel sheeting 0.5 millimeters thick, pretreated with a chromate solution.

The paint is applied using an applicator of bar coater type. Two types of application are carried out:

primer,

top coat.

In the case of the primer, the paint is applied to a bare metal sheeting so as to obtain a film with a dry thickness of 5 μm.

In the case of the top coat, the paint is applied to a metal sheeting coated with a primer with a dry thickness of 5 μm and in such a way as to obtain a top coat with a dry thickness of 18 μm.

The sheeting thus coated is introduced into a ventilated oven.

### Crosslinking Conditions

TABLE 5

| Coating | T (° C.) of | Peak T (° C.) of the |
|---|---|---|
| type | the oven | metal/time to reach it (s) |
| Primer | 385 | 232/45 |
| Top coat | 385 | 232/50 |

The primer, as primer and backing coat on the metal, is evaluated by virtue of the performance tests mentioned in table 6, after conditioning of the test panels in a climate-controlled room at 23° C.±2° where the humidity is controlled at 50%±5%.

The top coat is applied to the primer and the primer plus top coat system is evaluated by virtue of the performance tests mentioned in table 6, after conditioning of the test panels in a climate-controlled room at 23° C.±2° where the humidity is controlled at 50%±5%.

### Tests of Performance Qualities of the Coatings

TABLE 6

| Tests of the performance qualities | Method used |
|---|---|
| Resistance to methyl ethyl ketone | Visual method* |
| (s) or to methyl isobutyl ketone (s) | |
| Load 1 kg (MEK) or 500 g | |
| (MIBK)/linear Taber* | |
| Cupping test (mm) | NF EN ISO 1520 |
| Adhesion test | NF EN ISO 2409 |
| Adhesion + 8 mm indented | NF EN 13523-6 |
| Adhesion + 8 mm indented + | NF EN 13523-6 |
| 30 min at 90° C. | |
| T-bend test | NF EN 13523-7 |
| Persoz hardness (s) | NF EN ISO 1522 |
| Condensation tester (QCT) with | ISO 6270 |
| water at 40° C. | |
| Coverage (m²/kg/μm)** | |
| Gain in coverage (%)*** | |

*This method consists in carrying out to-and-fro movements over the sheeting with a device (Taber abrasion tester) soaked in solvent and consists in recording the time from which a deterioration in the coating is observed.
**Coverage = surface area in m² of metal recoatable with 1 kg of paint having a dry thickness of 1 μm.
The coverage is calculated according to the following formula from the dry paint density, the solids content and the coat thickness:
Coverage = (1 kg. Solids Content %)/(Dry Density kg/m³)/10⁻⁹ m
***The gain in coverage is the excess percentage of coverage with respect to a standard resin (% of improvement in the coverage).

### 3.2) Formulation and Preparation of a Paint for a Primer (see Table 7)

### Formulation of the Primer Paint

TABLE 7

| | | Compo- | | | |
|---|---|---|---|---|---|
| | | nent | | | |
| | Amount | ref- | Func- | Sup- | Chemical |
| Component | weight | erence | tion | plier | name |
| Resin in solvent | 265 | (1) | Binder | see tab | Polyester |
| (invention | | | tested | 2 - | |
| example 1 or | | | | | |
| comparative | | | | | |
| example 1) | | | | | |
| Solvarex ® 9 | 30 | (2) | Solvent | Total | Aromatic |
| | | | | | hydro- |
| | | | | | carbon |
| Butyl Diglycol | 30 | (3) | Solvent | Brenntag | Ether |
| | | | | | alcohol |
| Disperbyk ® 161 | 9 | (4) | Dispersing | Byk | Block |
| | | | agent | | polymer |
| Kronos ® 2360 | 83.1 | (5) | Pigment | Kronos | Titanium |
| | | | | | oxide |
| Shieldex ® C | 50.3 | (6) | Anti- | Grace | Silica |
| 303 | | | corrosion | | |
| | | | pigment | | |
| Heucophos ® | 50.3 | (7) | Anti- | | |
| SRPP | | | corrosion | | |
| | | | pigment | | |
| Aerosil ® R 972 | 6.5 | (8) | Rheo- | Evonik | Silica |
| | | | logical | | |
| | | | additive | | |
| Resin in solvent | 264 | (9) | Binder | see tab | Polyester |
| (invention | | | tested | 2 - | |
| example 1 and | | | | | |
| comparative | | | | | |
| example 1) | | | | | |
| Cymel ® 303 LF | 48 | (10) | Cross- | Allnex | Melamine |
| | | | linking | | |
| | | | agent | | |
| PTSA | 5.8 | (11) | Catalyst | BASF | para- |
| (10% butanol | | | | | Toluene- |
| w/w) | | | | | sulfonic |
| | | | | | acid |
| Epikote 828 | 10.1 | (12) | Binder | Dow | Epoxy |
| | | | | | resin |
| Solvarex ® 9 | 73.95 | (13) | Solvent | Total | Aromatic |
| | | | | | hydro- |
| | | | | | carbon |
| Butyl Diglycol | 73.95 | (14) | Solvent | Brenntag | Ether |
| | | | | | alcohol |
| Total | 1000 | | | | |

The components (1), (2), (3), (4), (5), (6), (7) and (8) are introduced, in this order, into a 1 liter beaker thermostatically controlled at ambient temperature. This mixture is stirred using a stirrer of Dispermat® type and then dispersed for 30 minutes at 3500 revolutions/minute in the presence of glass beads in order to facilitate the dispersion of the pigments.

The remainder of the binder (9) and the components (10), (11) and (12) are added with stirring at 1000 revolutions/minute.

Still with stirring at 1000 revolutions/minute, the viscosity of the paint is adjusted by virtue of the addition of the components (13) and (14) in sufficient amount to obtain a viscosity of between 300 mPa·s and 350 mPa·s at 25° C.

The primer paint thus obtained is filtered by sieving with removal of the glass beads.

The primer paint obtained exhibits the following characteristics (cf. table 8).

### Characteristics of the Primer Paint

TABLE 8

| Characteristic | Value |
|---|---|
| Dry density (g/cm³) | 1.45 |
| % Solids (by weight) | 57 (comparative example 1) |
| | 62.8 (invention example 1) |
| PVC* (%) | 16 |
| Cone-plate viscosity at 25° C. (mPa · s) | 360 (comparative example 1) |
| | 350 (invention example 1) |

*PVC: Pigment Volume Concentration

### 3.2.1) Application Results and Performance Qualities (Table 9)

TABLE 9

| | Comparative | Invention |
|---|---|---|
| Mechanical property | example 1 | example 1 |
| Resistance to methyl isobutyl ketone (s) | <10 | <10 |
| Load 500 g/linear Taber | | |
| Adhesion test | 0 | 0 |
| Adhesion + 8 mm indented | 0 | 0 |
| Adhesion + 8 mm indented + 30 min | 0 | 0 |
| at 90° C. | | |
| T-bend test | 1.5T | 1T |
| Persoz hardness (s) | 320 | 325 |
| Condensation tester (QCT) with water | 2S2 | 1S2 |
| at 40° C. - 500 h | | |
| Coverage (m²/kg/μm) | 393 | 433 |
| Gain in coverage (%) | — | 10.1 |

3.3) Formulation and Preparation of a Paint for a Top Coat (table 10)

List of the ingredients for a binder with a solids content tested adjusted to a solids content of 70% (with respective solvents described above, respectively for resins according to invention example 2 and comparative example 2)

TABLE 10

| | | Compo- | | | |
|---|---|---|---|---|---|
| | | nent | | | |
| | Amount | ref- | Func- | Sup- | Chemical |
| Component | weight | erence | tion | plier | name |
| Resin invention | 226 | (1) | Binder | see | Polyester |
| example 2 or | | | tested | tab. 4. | |
| comparative | | | | | |
| example 2 | | | | | |
| (solids | | | | | |
| content 70%) | | | | | |
| Solvarex ® 10 | 30 | (2) | Solvent | Total | Aromatic |
| LN | | | | | hydro- |
| | | | | | carbon |
| Butyl Diglycol | 30 | (3) | Solvent | Brenntag | Ether |
| | | | | | alcohol |
| Disperbyk ® 161 | 7.9 | (4) | Dispers- | Byk | Block |
| | | | ing | | polymer |
| | | | agent | | |
| Kronos ® 2360 | 310 | (5) | Pigment | Kronos | Titanium |
| | | | | | oxide |
| Syloid ® ED 40 | 26.8 | (6) | Filler | Grace | Silica |
| Aerosil ® R 972 | 3.2 | (7) | Rheo- | Evonik | Silica |
| | | | logical | | |
| | | | additive | | |
| Resin (solids | 174 | (8) | Binder | see | Polyester |
| content 70%) | | | | tab. 4 | |
| Cymel ® 303 LF | 54.6 | (9) | Cross- | Allnex | Melamine |
| | | | linking | | |
| | | | agent | | |
| PTSA | 11.1 | (10) | Catalyst | BASF | para- |
| (10% butanol | | | | | Toluene- |
| w/w) | | | | | sulfonic |
| | | | | | acid |
| Crayvallac ® | 3 | (11) | Spread- | Arkema | Polyester |
| Flow 200 | | | ing | | |
| | | | agent | | |
| Butyl diglycol | 61.7 | (12) | Solvent | Brenntag | Ether |
| | | | | | alcohol |
| Solvarex ® | 61.7 | (13) | Solvent | Total | Aromatic |
| 10 LN | | | | | hydrocarbon |
| Total | 1000 | | | | |

The components (1), (2), (3), (4), (5), (6) and (7) are introduced, in this order, into a 1 liter beaker thermostatically controlled at ambient temperature. This mixture is stirred using a stirrer of Dispermat type and then dispersed for 40 minutes at 3500 revolutions/minute. The remainder of the binder (8) and the compound (9) are subsequently added. The dispersing is continued at 2500 revolutions/minute for 15 minutes. Still while stirring at 1000 revolutions/minute, the components (10) and (11) are added and the viscosity of the paint is adjusted to between 500 and 550 mPa·s by virtue of the addition of solvent components (12) and (13).

The top coat is evaluated on a mechanical sheeting precoated with a primer described in 4.2).

The top coat (semi-gloss) exhibits the following characteristics (cf. table 11).

### Characteristics of the Top Coat

TABLE 11

| | | | | Cone-plate viscosity at | |
|---|---|---|---|---|---|
| Dry | | Solids content (%) | | 25° C. (mPa · s) | |
| density | PVC* | Comparative | Invention | Comparative | Invention |
| (g/cm³) | (%) | example 2 | example 2 | example 2 | example 2 |
| 1.75 | 23 | 63.5 | 71 | 510 | 500 |

*PVC: Pigment Volume Concentration

### 3.3.1) Application Results and Performance Qualities (Table 12)

TABLE 12

| | Value | |
|---|---|---|
| | Comparative | Invention |
| Characteristic/Test | example 2 | example 2 |
| Resistance to methyl ethyl ketone (s) | >100 | >100 |
| Load 1 kg/linear Taber | | |
| Cupping test (mm) | 0 | 0 |
| Adhesion test | 0 | 0 |
| Adhesion + 8 mm indented | 2 | 0 |
| Adhesion + 8 mm indented + 30 min at | 3 | 0 |
| 90° C. | | |
| T-bend test | 2T | 2T |
| Persoz hardness (s) | 240 | 243 |
| Condensation tester (QCT) with water | 2S2 | 1S2 |
| at 40° C. - 500 h | | |
| Coverage (m²/kg/μm) | 362 | 406 |
| Gain in coverage (%) | 0 | 12.1 |

1. A hydroxylated and/or carboxylated polyester resin, comprising in its structure, ester units formed from a polyol component a) comprising at least one polyol al) chosen from fatty acid triglycerides:
R—CO₂—(H)C—(CH₂CO₂—R)₂ (I)
with R being the residue radical without a carboxyl group of a hydroxylated and/or epoxidized fatty acid RCO₂H with R comprising from 13 to 21 carbon atoms and at least one hydroxyl and/or epoxy group.

2. The polyester resin as claimed in claim 1 wherein said triglyceride is chosen from the triglycerides of 9- and/or 10-hydroxystearic acid, 12-hydroxystearic acid, 14-hydroxyeicosanoic acid, 12-hydroxy-9-octadecenoic acid and/or its epoxidized form, lesquerolic (14-hydroxy-cis-11-eicosenoic) acid and/or its epoxidized form, and epoxidized soybean oil.

3. The polyester resin as claimed in claim 1 wherein said hydroxylated fatty acid triglyceride is 12-hydroxystearic acid or 12-hydroxy-9-octadecenoic acid, wherein said triglyceride is hydrogenated or nonhydrogenated castor oil.

4. The polyester resin as claimed in claim 1 wherein the content by weight of said polyol triglyceride a1) with respect to the weight of said resin varies from 1% to 30%.

5. The polyester resin as claimed in claim 1 wherein said polyol component a) comprises, in addition to said polyol a1):
a2) at least one C₂ to C₆ diol carrying at least one methyl side substituent.

6. The resin as claimed in claim 1 wherein said polyol component a) additionally comprises:
a3) at least one linear C₂ to C₆ aliphatic diol, without any alkyl side substituent, and/or one C₆ to C₁₀ cycloaliphatic diol and/or one C₃₂ to C₃₆ fatty diol.

7. The resin as claimed in claim 1 wherein said polyol component a) additionally comprises:
a4) at least one polyol of functionality >2,
and wherein said resin has a branched structure.

8. The resin as claimed in claim 1 having a polyacid component b) which comprises:
b1) at least one aromatic diacid or its anhydride,
b2) optionally, at least one linear C₄ to C₁₀ aliphatic diacid and/or one C₃₂ to C₃₆ fatty acid dimer diacid,
b3) optionally, at least one cycloaliphatic diacid.

9. The resin as claimed in claim 1 wherein said polyol a2) is a diol selected from: methylethylene glycol, methylpropanediol, neopentyl glycol (2,2-dimethyl-1,3-propanediol), dimethylbutanediol and 2-butyl-2-ethyl-1,3-propanediol.

10. The resin as claimed in claim 1 wherein said polyol a2) represents less than 75% by weight of said polyol component a).

11. The resin as claimed in claim 1 wherein said resin has a hydroxyl number of 10 to 120, of 15 to 100, of 20 to 80, of 25 to 75, of 30 to 60 or of 35 to 50 mg KOH/g.

12. The resin as claimed in claim 1 wherein said resin has a carboxyl number of less than or equal to 20, of less than or equal to 15, of less than or equal to 10, of less than or equal to 7 or of less than or equal to 5 mg KOH/g.

13. The resin as claimed in claim 1 having a glass transition temperature, measured by DSC, at 10° C./min, of −10° C. to 100° C.

14. The resin as claimed in claim 1 wherein at least 50% by weight of said resin is biobased.

15. The resin as claimed in claim 1 which is hydroxylated.

16. The resin as claimed in claim 1 having a number-average molecular weight Mₙ (calculated) ranging from 500 to 20,000.

17. A solution of resin in an organic solvent comprising in addition to said solvent, at least one resin as defined in accordance with claim 1.

18. The solution as claimed in claim 17 having a content by weight of said resin with respect to resin+solvent total weight of at least 50%.

19. A coating composition comprising at least one resin as defined in accordance with claim 1.

20. The composition as claimed in claim 19 which is crosslinkable and comprises, in addition to said resin, at least one crosslinking agent carrying groups which react with the reactive groups of said resin.

21. The composition as claimed in claim 20, wherein said crosslinking agent is selected from melamine, benzoguanamine a polyisocyanate, blocked polyisocyanate, a polyanhydride, a polysilane, and alkoxy-blocked polysilane, when said resin is hydroxylated, or said crosslinking agent is selected from polyepoxides and polyols when said resin is carboxylated.

22. The composition as claimed in 20, which is a coating composition in an organic solvent medium.

23. The composition as claimed in claim 22 which is a paint or varnish composition.

24. The composition as claimed in 22, which is a paint or varnish composition for metal surfaces.

25. The composition as claimed in claim 18 comprising in addition to said resin and said crosslinking agent, at least one pigment.

26. (canceled)

27. (canceled)

28. (canceled)

29. (canceled)

30. (canceled)

31. (canceled)

32. (canceled)
